(19) United States
(12) Patent Application Publication
(10) Pub. No.: US 2006/0212375 A1
(43) Pub. Date: Sep. 21, 2006

(54) Method for venture project financing

(76) Inventors: Sebastien Funez, Los Angeles, CA (US); Philippe Funez, Montreal (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/084,099

(22) Filed: Mar. 21, 2005

(51) Int. Cl. G06Q 40/00

(52) U.S. Cl. 705/35

(57) ABSTRACT

A method for raising funds for investment in a venture project is provided. An investment agent sets up an agreement with an entrepreneur of for raising funds, up to a threshold amount, to finance the project within a first time limit and for a given return on investment. The investment agent providing details of the venture project in which individual investors may invest. Each investor sets up a contract with the investment agent for participating in the financing of the venture project, the contract specifying an investment amount and the return rate on investment. If the funds raised are less than the threshold amount, the entrepreneur may raise additional funds up to the threshold amount from other financing sources, within a second time limit. Following commercial operation of the venture project, the entrepreneur paying a share of the profits to the investment agent and the investment agent distributing to each individual investor an amount of the share of profits.

### FIELD OF THE INVENTION

The invention relates to the field of finance. More specifically, it relates to a method of raising funds for investment in a venture project from a plurality of investors.

### BACKGROUND OF THE INVENTION

Entrepreneurs, especially in the arts industry, such as cinema and music, often have difficulties financing projects due to the high upfront investments required and the inherent risks associated with such start-up projects.

Traditional financing sources, such as banks, are cautious and not very inclined to invest the large sums of money required by these start-up projects, since, at an early stage, the entrepreneurs have few tangible assets that can be used as collaterals. Seed and early stage capital has historically been limited by securities regulations and restricted the potential investor pool to high net worth or high income accredited investors.

Typically, entrepreneurs turn to venture capitalists in order to raise funds for such high-risk business projects. Venture capitalists usually seek a high return on investment and are compensated with large equity ownership in the project (such as voting rights, place on board of directors, etc.) The problem is that venture capitals investors are usually interested in investing large sums of money and usually the financing of a project depends on finding enough venture capital investors that together will invest a sufficient amount to start the project.

Prior art systems and methods for raising funds from a pool of investors for a potential investment do not guarantee a time limit by which the funds required are to be raised and are therefore inconvenient for an entrepreneur whose commercial operation of a project might be delayed indefinitely.

### SUMMARY OF THE INVENTION

Accordingly, an object of the present invention is to provide a method and system allowing an entrepreneur to maximize the opportunities of financing a venture project within a given time limit by reaching a pool of small and large investors.

According to a first broad aspect of the present invention, there is provided a method for raising funds for investment in a venture project, comprising: an investment agent setting up an agreement with an entrepreneur of the venture project, for raising funds, up to a threshold amount, to finance the project, the agreement defining: a fixed return on investment for the investment agent, the return being independent of the funds raised and a first time limit for raising the funds; the investment agent providing details of at least one venture project in which individual investors may invest; an investor selecting a venture project for investment; the investor setting up a contract with the investment agent for participating in the financing of the venture project, the contract specifying an investment amount and the return rate on investment; after the agreed time limit elapses, if the funds raised are less than the threshold amount, the entrepreneur raising additional funds up to the threshold amount from other financing sources, within a second time limit; if the additional funds raised within the second time limit are less than the threshold amount, the party returning the raised funds to the investment company; if the threshold amount is raised, following commercial operation of the venture project, the entrepreneur paying a share of the profits from the commercial operation to the investment agent, as specified by the agreement and the investment agent distributing to each individual investor an amount of the share of profits, in accordance with the contract.

### BRIEF DESCRIPTION OF THE DRAWINGS

These and other features, aspects and advantages of the present invention will become better understood with regard to the following description and accompanying drawings wherein:

FIG. 1 is a block diagram of the interaction between the parties involved in the financing of a venture project according to one embodiment of the present invention;

FIG. 2 is a flow chart of a method for raising funds for investment in a venture project according to the preferred embodiment of the present invention;

FIG. 3 is a block diagram of a web-based system for distribution of information regarding venture project investment opportunities according to the preferred embodiment of the present invention.

### DETAILED DESCRIPTION OF THE PREFERRED EMBODIMENT

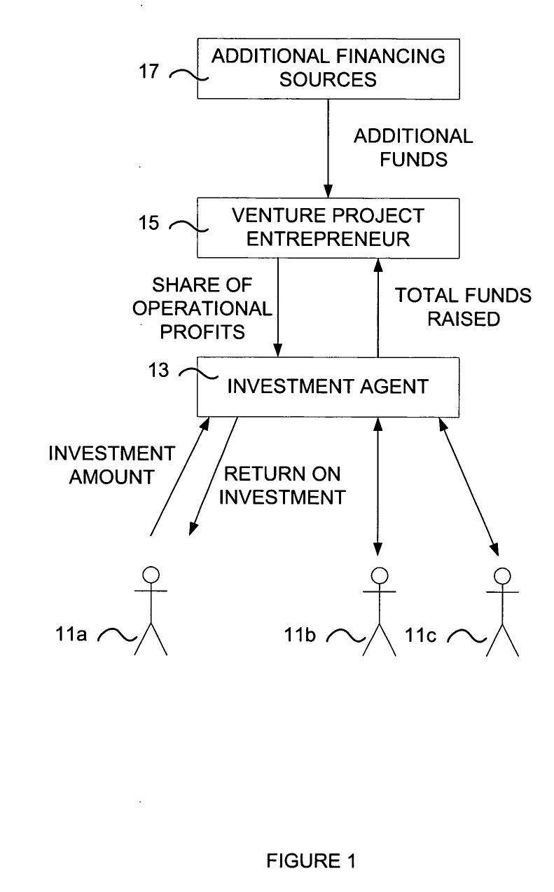

With respect to FIG. 1, the parties involved in the financing of a venture project according to one embodiment of the present invention will be described. A venture project entrepreneur 15 is any private or public entity that seeks funds in order to finance a venture project. A venture project, as has been described in the background of the invention, is usually a new high-risk undertaking providing the possibility of a large financial return, while risking large capital losses. The system and method of the present invention could, for example, be applied for financing venture projects in the movie industry, such as films, television shows, cartoons, as well as the music industry, such as album recordings, concerts, shows, etc. In the movie industry, examples of entrepreneurs include a studio looking to finance a new movie production or a distributor seeking financing for the release and distribution of a foreign production. Other examples of venture projects include, but are not limited to, university/scientific research projects and any other business venture projects across a variety of industries.

An investment agent 13 is the intermediary enabling the system and method of the present invention by providing the project entrepreneur 15 with the opportunity to obtain project financing by reaching a pool of investors 11 and providing the investors 11 with the opportunity to invest in a project and receive a return on investment. The investment agent 13 is responsible for providing access to descriptions of venture project offerings to potential investors 11. The information regarding the venture project includes details regarding the nature of the project, the total funds needed, the return on investment expected, the start date of commercial operation and expected date for paying out the return on investment, etc. The information is preferably made available on a website, accessible through a network, but can alternatively be provided through other distribution means, such as catalogs, magazines, specialized investment advisors and investment networks, banks, etc. In the preferred embodiment of the present invention, an investment agent 13 serves a plurality of venture project entrepreneurs 15 by offering information regarding a plurality of venture projects to investors 11. Investors 11 can therefore access a list of venture projects for which entrepreneurs 15 are seeking financing and compare between them in order to make a choice for an investment.

Investors 11 are either individuals or groups and can include accredited investors, as well as members of the general public.

Still with respect to FIG. 1, additional financing sources 17 refers to organizations or individuals that would provide additional funds to the venture project entrepreneurs 15 in the case in which the total funds raised by the investment agent 13 would not be sufficient for the venture project to be operational. Such additional sources include banks, venture capital investors, etc.

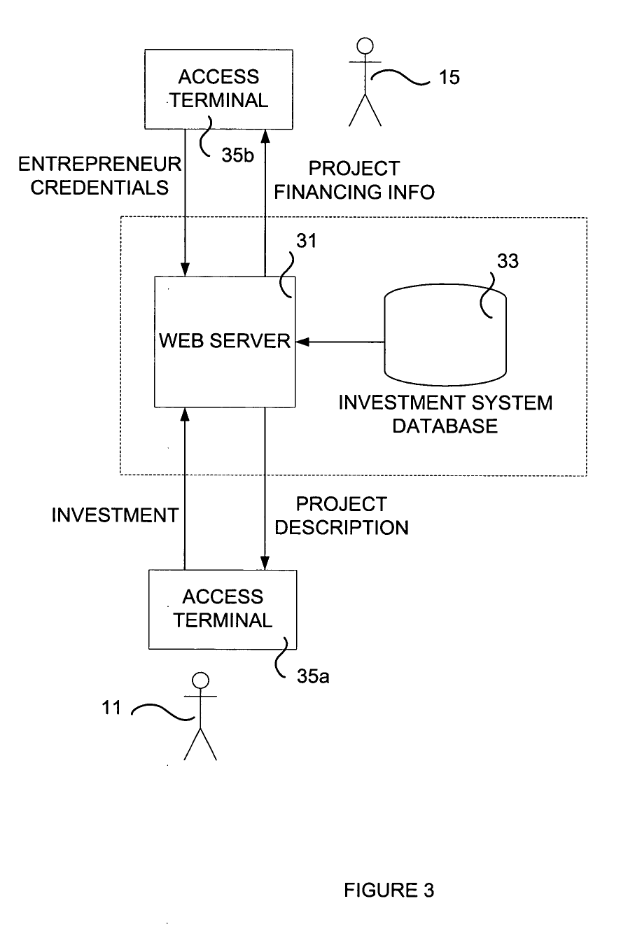

Now, referring to FIG. 3, there is illustrated a block diagram of a system for web browser-based distribution of venture project information to potential investors 11. The distribution system set up by the investment agent 13 includes a web server 31 and an investment system database 33. In the preferred embodiment of the present invention, the web server 31 is a secure server protected by firewall and encryption technologies in order to ensure security of the information stored in the database 33. The investors 11 and the entrepreneurs 15 may access the system through a public communication network such as the Internet or through a private LAN/WAN network. Investors 11 at an access terminal 35 may communicate with the system via any suitable transmission media, such as an ordinary public telephone line, a data quality line, a radio link or any other transmission media suitable for inter-computer communication. An example of access terminal 35 used for accessing the system is a computer platform running a web-browser application. Any terminal 35 with web-browsing abilities, such as a personal computer, a web-enhanced cellular phone or a personal digital assistant may be used. In the preferred embodiment of the present invention, the investor 11 accesses the information through an investment system website, by using any commercially available Internet web browser, such as Microsoft Internet Explorer™ or Netscape Navigator™.

From an access terminal, upon requesting the Uniform Resource Locator (URL) address corresponding to the investment system website, a web page is loaded in the potential investor's browser. Access to the investment system website contents can be controlled using a variety of security mechanisms, including 128-bit SSL encryption. In the preferred embodiment of the present invention, the venture project description sections of the website are not access restricted, so that any potential investor may browse and consult freely the details of each project. However, access to certain sections of the website, in particular the sections containing details regarding financial details for a project, are restricted by requiring the user's identification credentials (typically a username and password), which may be obtained by registering with the investment system. If an investor 11 is not yet registered with the investment system, upon trying to access an access-restricted section of the website, a registration page is loaded in the investor's browser. The registration page includes a form with investor information fields to be completed by the potential investor 11. Such investor registration information includes a username, password, name, contact information, payment information, etc. Upon providing the required information, an investor account is created and stored on the investment system database 33.

Following registration, the investor 11 may choose to invest in one of the venture projects suggested on the investment system website. The information provided for each project depends on the nature and the field of the project. In the preferred embodiment of the present invention, the information provided includes general content such as the business plan of the organization seeking financing, a description of the artistic project (for movies, music, etc.) or of the technology involved (for an industrial type of project), marketing and operational strategy, financial objectives, projected use of funds and return on investment, etc.

Preferably for artistic projects, but also for other types of projects, the venture project information provided on the website includes multimedia files providing additional details regarding the project. Such multimedia files might include audio/video files, power point presentations, animations, or any combination thereof. Additionally, the investment system website may contain sections allowing the investor to solicit additional information regarding a venture project investment, which could be delivered by email, fax, regular mail or other means.

The venture project descriptions are preferably organized by project field (movies, music, etc.) and further classified into current and upcoming projects, listed by country. For each country, for a movie project, the information presented will include the name of the production company and background information regarding past projects, the name of the project, the name of the director, the actors, a summary of the screenplay, etc.

The investment system website could also include, in one embodiment of the present invention, a contest section, providing the opportunity to emerging artists and directors to win an initial investment and the listing of the venture project on the website in order to attract investors 11 and raise funds.

In one embodiment of the present invention, an entrepreneur 15 can also register with the investment system by creating an entrepreneur account through the website and submitting a venture project financing request for evaluation by the investment agent 13. Once the investment agent 13 approves the venture project financing request, the venture project description and related information are added on the website for consultation by potential investors 11. The entrepreneur 15 can then at any time log into the website in order to consult details of the venture project financing process, such as a list of all investment amounts and investors 11.

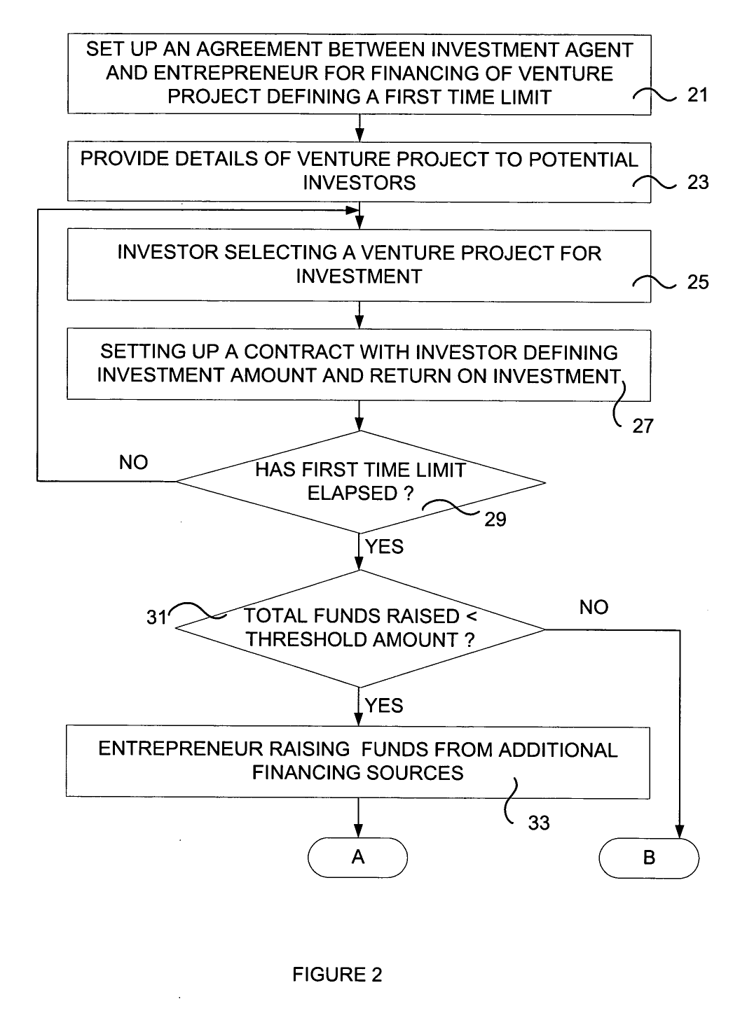

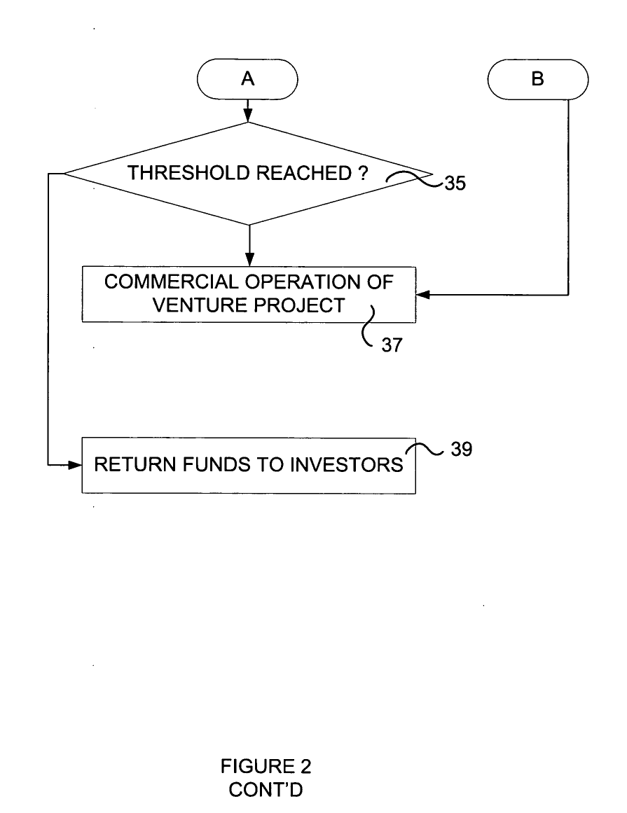

Now, with respect to FIG. 2, a method for raising funds for investment in a venture project according to the preferred embodiment of the present invention will be described. In a first step 21, once the investment agent 13 accepted the project, the investment agent and the entrepreneur set up an agreement for financing the venture project. The agreement preferably defines a first time limit for raising the funds, for example, 90 days from the day the details of the project are first made available to investors 11. The agreement also defines that the share of operational profits distributed to the investment agent 13 by the entrepreneur 15 is a percentage calculated as a function of the funds raised by the investment agent 13, with respect to the total funds required for the venture project.

An example of the financial terms of an agreement between an investment agent 13 and an entrepreneur 15 will be described below referring to the financing of a movie production. Assuming that a budget of $ 10,000,000 is necessary in order to produce the movie, the agreement can define that the investment agent 13 is responsible for raising $ 5,000,000 from investors 11 through the investment system. The agreement can further stipulate that the investment agent 13 will receive from the entrepreneur 15, following the release of the movie, a share of the profits, for example, 11%. Assuming that the total profits are of $ 10,000,000, the investment agent 13 will receive $1,100,000 from the entrepreneur 15.

Following the agreement, in a next step 23, the details of the venture project are presented by means of the investment agent website to potential investors, as described above. Then, in a following step 25, an investor, after reviewing the details of the venture project, selects a venture project for investment. Then, in a next step 27, the investor and the investment agent 13 set up a contract defining the terms and conditions of the investment. For example, the contract defines the investment amount and the expected return on investment, which can either be fixed or vary as a percentage of the total funds raised by the investment agent 13.

The investment amount is not fixed by the investment system, but can be any amount chosen by the investor 11.

For the example described above, for an investor 11 investing $100 in the venture project, the return on investment is calculated as a percentage of the total funds raised by the investment agent 13. If the investment agent 13 raises a total of $ 5,000,000, then the return on investment corresponding to an investment amount of $100 is 0.002% of the share of profits received by the investment agent 13. In this case, 0.002% of $ 1,100,000 representing a return on investment of $22. The investor 11 will therefore receive $122 from the investment agent 13, representing the initial investment amount of $100 plus the return on investment of $22.

The actual amount the investor 11 receives from the investment agent 13 may be less in the case in which the investment agent 13 charges additional management fees.

Returning to the method of FIG. 2, in a next step 29, the system checks whether the first time limit for raising the funds, as defined in the agreement between the investment agent 13 and the entrepreneur 15. If the time limit has elapsed, in step 31 the system checks whether the total funds raised within the first time limit are less than a threshold amount needed by the entrepreneur 15 to start the venture project. If the total funds raised exceed the threshold amount, then the entrepreneur 15 receives the funds from the investment agent 13 and starts the commercial operation of the venture project, as per step 37. If, however, the total funds raised by the first time limit are less than the threshold amount, the entrepreneur 15 has the opportunity, as per step 33, to raise additional funds from other financing sources, within a second time limit. Such additional funding sources include venture capital investments or bank loans, etc.

At the end of the second time limit, an additional check is performed, as per step 35, whether the additional funds raised within the second time limit are sufficient, in comparison to the threshold amount. If the additional funds raised are less than the threshold amount needed for commercial operation, the funds are returned to the individual investors. If, however, the funds raised are sufficient, the entrepreneur can use them to start the commercial operation of the venture project. Following commercial operation of the project, the entrepreneur pays a share of the profits to the investment agent, as specified by the agreement. In turn, the investment agent distributes to each individual investor an amount of the share of profits, in accordance with the contract.

Alternatively or in addition to distributing the share of profits to the individual investors 11, the investment agent 13 may suggest that the amount of share of profits, whole or partly, be reinvested for funding a different venture project.

Some other features of the present invention will now be described. While in the preferred embodiment of the present invention the threshold amount is fixed at the time the investment agent sets up the agreement with the entrepreneur, in alternative embodiments, it may be possible for the entrepreneur to modify the threshold amount needed at any time during the first time limit for raising the funds. Such a modification may occur, for example, if some of the planned expenses of the original production budget turn out to be lower than expected. Alternatively, the entrepreneur may need to increase the threshold amount in the case in which the amount needed to finance the project is increased due to unexpected new expenses.

In the case in which investors 11 would like to be refunded their investment before the first time limit has elapsed, they will have the opportunity to do so. Similarly, the contract between the investor 11 and the investment agent 13 will provide a clause allowing the investor 11 to transfer the investment and all rights associated to it to a third party.

Depending on the risk associated with each venture project, the investment agent 13 will contract an insurance program allowing to fully reimburse the investors' initial investment. For example, for a movie production, one type of insurance could cover any accidents that could occur while shooting the movie. Another type of insurance could cover the period of commercial release of the movie, and in particular, the case in which the profits would be insufficient, with respect to the production costs, to return the initial investment to the investors.

According to the preferred embodiment of the present invention, the investment agent 13 will be financed by the interest on the funds raised before the funds are provided to the entrepreneur. The investment agent 13 will also keep a share of the profits received from the entrepreneur 15. For example, if according to the agreement between the investment agent 13 and the entrepreneur 15, the investment agent 13 is to receive 15% of the total profits, the investment agent 13 might keep 5% of the profits and distribute the remaining 10% as return on investment to the investors 11. The investment agent 13 will also receive, from each investor 11, an amount corresponding to management/service fees. This amount could be paid at the time of registration by the investor 11 or it could be subtracted from the amount to be distributed to the investor 11 by the investment agent 13.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

What is claimed is:

1. A method for raising funds for investment in a venture project, comprising:
an investment agent setting up an agreement with an entrepreneur of said venture project, for raising funds, up to a threshold amount, to finance said project, the agreement defining:
a fixed return on investment for said investment agent, the return being independent of the funds raised and
a first time limit for raising said funds;
the investment agent providing details of at least one venture project in which individual investors may invest;
an investor selecting a venture project for investment;
said investor setting up a contract with the investment agent for participating in the financing of said venture project, the contract specifying an investment amount and the return rate on investment;
after the agreed time limit elapses, if the funds raised are less than said threshold amount, said entrepreneur raising additional funds up to said threshold amount from other financing sources, within a second time limit;
if said additional funds raised within said second time limit are less than said threshold amount, the party returning the raised funds to the investment company;
if said threshold amount is raised, following commercial operation of said venture project, said entrepreneur paying a share of the profits from said commercial operation to said investment agent, as specified by the agreement and said investment agent distributing to each individual investor an amount of the share of profits, in accordance with said contract.

2. A method as claimed in claim 1, wherein said amount distributed to each investor includes said investment amount and an amount as defined by said return rate on investment of said contract.

3. A method as claimed in claim 1, wherein said distributing comprises:
said investment company reinvesting said amount of the share of profits for funding a different venture project.

4. A method as claimed in claim 1, wherein said obtaining additional funds from other financing sources comprises:
said entrepreneur obtaining a bank loan.

5. A method as claimed in claim 1, wherein said contract further comprises a guarantee of return of said funds to said investors in case of commercial failure of said venture project, the method further comprising:
in the case in which said venture project is not a commercial success, each investor receiving back said investment amount.

6. A method as claimed in claim 5, further comprising each investor receiving said investment amount and a return according to current interest rates over the investment period.

7. A method as claimed in claim 1, wherein said return rate on investment for each investor specified in said contract is recalculated dynamically depending on the funds raised from all investors.

8. A method as claimed in claim 1, wherein said investment agent subtracts an amount for management fees from said amount distributed to said investors.

9. A method as claimed in claim 1, wherein said threshold amount is not fixed and further comprising the step of said investor changing said threshold amount during said first time limit for raising said funds.
